(19) United States
(12) Patent Application Publication
(10) Pub. No.: US 2024/0103406 A1
(43) Pub. Date: Mar. 28, 2024

(54) RECORDING MEDIUM TRANSPORT AND TRANSFER BELT, BELT UNIT, AND IMAGE FORMING APPARATUS

(71) Applicant: FUJIFILM Business Innovation Corp., Tokyo (JP)

(72) Inventors: Makoto OCHIAI, Kanagawa (JP); Minoru ROKUTAN, Kanagawa (JP); Satoya SUGIURA, Kanagawa (JP); Shogo HAYASHI, Kanagawa (JP)

(73) Assignee: FUJIFILM Business Innovation Corp., Tokyo (JP)

(21) Appl. No.: 18/190,108

(22) Filed: Mar. 26, 2023

(30) Foreign Application Priority Data
Sep. 27, 2022 (JP) 2022-154082

(51) Int. Cl. G03G 15/16

(52) U.S. Cl. CPC G03G 15/162; G03G 15/1615; G03G 15/1685; G03G 2215/1623

(57) ABSTRACT

A recording medium transport and transfer belt includes at least a base material layer and a surface layer, in which a ratio (ρs₅₀₀/ρv₅₀₀) between surface resistivity ρs₅₀₀ and volume resistivity ρv₅₀₀ at an applied voltage of 500 V is 1.0 or more, and a difference (ρs₁₀₀−ρs₅₀₀) between surface resistivity ρs₁₀₀ at an applied voltage of 100 V and surface resistivity ρs₅₀₀ at an applied voltage of 500 V is 0.3 or less.

### CROSS-REFERENCE TO RELATED APPLICATIONS

This application is based on and claims priority under 35 USC 119 from Japanese Patent Application No. 2022-154082 filed Sep. 27, 2022.

### BACKGROUND

### (i) Technical Field

The present invention relates to a recording medium transport and transfer belt, a belt unit, and an image forming apparatus.

### (ii) Related Art

In an electrophotographic image forming apparatus, a recording medium transport and transfer belt for transporting a recording medium and transferring an image to the recording medium is used.

For example, JP2006-84707A discloses an electrophotographic transfer belt in which a front surface coating layer and a back surface coating layer are provided on front and back surfaces of a rubber layer, and when a common logarithmic value of volume resistivity of the front surface coating layer is defined as Rv1 (log Ωcm), a common logarithmic value of volume resistivity of the rubber layer is defined as Rv2 (log Ωcm), and a common logarithmic value of volume resistivity of the back surface coating layer is defined as Rv3 (log Ωcm), a relationships of the following expressions (1) to (3) are simultaneously satisfied.

Rv1>Rv2 Expression (1):

Rv1>Rv3 Expression (2):

Rv3>Rv2 Expression (3):

JP1996-185068A discloses an image forming belt that transports a transfer material to a transfer region facing an image carrier carrying an image forming substance, moves the image forming substance from the image carrier to the transfer material by an electric field, and electrostatically attracts and transports the transfer material, and in which the belt is made of a rubber elastic body and volume specific resistance in a thickness direction is 10⁹ Ω·cm or less.

JP2002-268408A discloses an image forming apparatus having a transfer and transport belt that transports transfer paper to a drum-shaped photoconductor, transfers toner from the photoconductor to the transfer paper by an electric field, and electrostatically attracts and transports the transfer paper, and in which volume resistance Rᵥₒₗ of the transfer and transport belt is in the range of 10⁸ to 10¹¹Ω, and a relationship between the volume resistance Rᵥₒₗ and surface resistance ρ_{surf} of an inner surface layer satisfies (ρ_{surf})<=7E+20(Rᵥₒₗ)^{-1.1}.

### SUMMARY

Aspects of non-limiting embodiments of the present disclosure relate to a recording medium transport and transfer belt that has at least a base material layer and a surface layer, and in which image transfer performance is excellent and recording medium transport performance is also excellent, as compared with a case where a ratio (ρs₅₀₀/ρv₅₀₀) between surface resistivity ρs₅₀₀ and volume resistivity ρv₅₀₀ at an applied voltage of 500 V is less than 1.0, or a difference (ρs₁₀₀−ρs₅₀₀) between surface resistivity ρs₁₀₀ at an applied voltage of 100 V and surface resistivity ρs₅₀₀ at an applied voltage of 500 V exceeds 0.3.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a recording medium transport and transfer belt including at least a base material layer and a surface layer, in which a ratio (ρs₅₀₀/ρv₅₀₀) between surface resistivity ρs₅₀₀ and volume resistivity ρv₅₀₀ at an applied voltage of 500 V is 1.0 or more, and a difference (ρs₁₀₀−ρs₅₀₀) between surface resistivity ρs₁₀₀ at an applied voltage of 100 V and surface resistivity ρs₅₀₀ at an applied voltage of 500 V is 0.3 or less.

### BRIEF DESCRIPTION OF THE DRAWINGS

Exemplary embodiment(s) of the present invention will be described in detail based on the following figures, wherein:

FIGS. 1A and 1B are diagrams showing an example of a circular electrode, in which FIG. 1A is a schematic plan view and FIG. 1B is a schematic cross-sectional view;

FIG. 2 is a schematic perspective view showing an example of a recording medium transport and transfer belt according to the present disclosure;

FIG. 3 is a schematic perspective view showing an example of a belt unit according to the present disclosure; and

FIG. 4 is a schematic configuration diagram showing an example of an image forming apparatus according to the present disclosure.

### DETAILED DESCRIPTION

Hereinafter, an exemplary embodiment of the present invention will be described. The description and examples are for exemplifying the exemplary embodiment and do not limit the scope of the exemplary embodiment.

In the numerical ranges described stepwise in the present specification, an upper limit value or a lower limit value described in one numerical range may be replaced with an upper limit value or a lower limit value of the numerical range described in other steps.

Further, in the numerical ranges described in the present specification, an upper limit value and a lower limit value of the numerical range may be replaced with values shown in examples.

In the present specification, each component may contain multiple types of corresponding substances.

In a case where the amount of each component in a composition is referred to in the present specification, when multiple types of substances corresponding to each component are present in the composition, unless otherwise specified, the amount refers to the total amount of the multiple types of substances present in the composition.

Recording Medium Transport and Transfer Belt

A recording medium transport and transfer belt according to the present disclosure includes at least a base material layer and a surface layer, in which a ratio (ρs₅₀₀/ρv₅₀₀) between surface resistivity ρs₅₀₀ and volume resistivity ρv₅₀₀ at an applied voltage of 500 V is 1.0 or more, and a difference (ρs₁₀₀−ρs₅₀₀) between surface resistivity ρs₁₀₀ at an applied voltage of 100 V and surface resistivity ρs₅₀₀ at an applied voltage of 500 V is 0.3 or less.

Hereinafter, the recording medium transport and transfer belt according to the present disclosure will also be simply referred to as a “belt according to the present disclosure”.

The recording medium transport and transfer belt according to the present disclosure is a belt involved in both the transport of a recording medium such as paper and the transfer of a toner image to the recording medium.

Specifically, the recording medium transport and transfer belt according to the present disclosure is applied to a belt that is disposed to face an intermediate transfer belt and transports a recording medium to a secondary transfer unit, in an image forming apparatus that primarily transfers a toner image formed on a surface of an image carrier (also referred to as an electrophotographic photoconductor or photoconductor) to the intermediate transfer belt, and then secondarily transfers the toner image from the intermediate transfer belt to the recording medium. Further, the belt according to the present disclosure is applied to a belt that is disposed to face an image carrier and transports a recording medium to a transfer part, in an image forming apparatus that directly transfers a toner image formed on a surface of the image carrier to the recording medium.

The recording medium transport and transfer belt that is used in an electrophotographic image forming apparatus transports a recording medium while electrostatically attracting the recording medium to the surface thereof at the transfer part, and also contributes to the transfer of a toner image to the recording medium that is transported, as described above.

For this reason, the recording medium transport and transfer belt is required to have, for example, both image transfer performance and recording medium transport performance. Here, the recording medium transport performance means that the recording medium is transported in a state of being attracted to the recording medium transport and transfer belt without being attracted to the intermediate transfer belt or image carrier side at the transfer part.

The image transfer performance and the recording medium transport performance are often affected, for example, in a case where abnormal discharge occurs at the transfer part (for example, the transfer part between the intermediate transfer belt and the image carrier), or a case where transfer conditions are changed according to the type of the recording medium, environment, or the like.

Therefore, the inventors of the present invention conducted studies, and as a result, found that both the image transfer performance and the recording medium transport performance can be improved by making a layer configuration having at least a base material layer and a surface layer and also controlling each of volume resistivity and surface resistivity, and resulted in the configuration of the belt according to the present disclosure described above.

In the belt according to the present disclosure, a ratio (ρs₅₀₀/ρv₅₀₀) between surface resistivity ρs₅₀₀ and volume resistivity ρv₅₀₀ at an applied voltage of 500 V is set to be 1.0 or more, and a difference (ρs₁₀₀−ρs₅₀₀) between surface resistivity ρs₁₀₀ at an applied voltage of 100 V and surface resistivity ρs₅₀₀ at an applied voltage of 500 V is set to be 0.3 or less. The ratio (ρs₅₀₀/ρv₅₀₀) is set to be 1.0 or more, so that the surface resistance of the belt can be increased and the transfer performance can be improved. Further, the difference (ρs₁₀₀−ρs₅₀₀) is set to be 0.3 or less, so that the voltage dependence of the surface resistance of the belt can be kept low. In this way, a change in surface properties due to energization (also including discharge) to the surface of the belt at the transfer part can be suppressed without lowering the transfer performance, and a decrease in the recording medium transport performance can also be suppressed.

Therefore, the belt according to the present disclosure is presumed to have excellent image transfer performance and excellent recording medium transport performance.

Surface Resistivity and Volume Resistivity

In the belt according to the present disclosure, the ratio (ρs₅₀₀/ρv₅₀₀) between the surface resistivity ρs₅₀₀ and the volume resistivity ρv₅₀₀ at an applied voltage of 500 V is 1.0 or more.

From the viewpoint of further improving the image transfer performance and the recording medium transport performance, the ratio (ρs₅₀₀/ρv₅₀₀) is preferably, for example, 1.15 or more and more preferably, 1.2 or more . . . .

In the belt according to the present disclosure, the difference (ρs₁₀₀−ρs₅₀₀) between the surface resistivity ρs₁₀₀ at an applied voltage of 100 V and the surface resistivity ρs₅₀₀ at an applied voltage of 500 V is set to be 0.3 or less.

From the viewpoint of further improving the image transfer performance and the recording medium transport performance, the difference (ρs₁₀₀−ρs₅₀₀) is preferably, for example, 0.25 or less and more preferably, 0.2 or less.

In the belt according to the present disclosure, from the viewpoint of further improving the image transfer performance and the recording medium transport performance, the surface resistivity ρs₅₀₀ at an applied voltage of 500 V is preferably, for example, 9.5 log Ω/□ or more, more preferably 9.5 log Ω/□ or more and 12.7 log Ω/□ or less, further preferably, 9.5 log Ω/□ or more and 12.0 log Ω/□ or less, and particularly preferably, 9.7 log Ω/□ or more and 11.5 log Ω/□ or less.

Further, the surface resistivity ρs₁₀₀ at an applied voltage of 100 V may be any value as long as the value is a value that makes the difference (ρs₁₀₀−ρs₅₀₀) between the surface resistivity ρs₁₀₀ and the surface resistivity ρs₅₀₀ at an applied voltage of 500 V 0.3 or less, and is preferably, for example, 9.5 log Ω/□ or more and 12.0 log Ω/□ or less.

The volume resistivity ρv₅₀₀ at an applied voltage of 500 V in the belt according to the present disclosure may be any value as long as the value is a value that makes the ratio (ρs₅₀₀/ρv₅₀₀) between the volume resistivity ρv₅₀₀ and the surface resistivity ρs₅₀₀ at an applied voltage of 500 V 1.0 or more, and is preferably, for example, 9.5 log Ω·cm or more, more preferably, 9.5 log Ω·cm or more and 12.0 log Ω·cm or less, and more preferably, 9.7 log Ω·cm or more and 11.5 log Ω·cm or less.

Further, the volume resistivity ρv₅₀₀ at an applied voltage of 500 V is preferably, for example, 7.0 log Ω·cm or more and 12.0 log Ω·cm or less.

In the belt according to the present disclosure, from the viewpoint of further improving the image transfer performance and the recording medium transport performance, it is preferable that the volume resistivity ρv1₅₀₀ of the base material layer at an applied voltage of 500 V is smaller than, for example, the volume resistivity ρv2₅₀₀ of the surface layer at an applied voltage of 500 V.

The volume resistivity ρv1₅₀₀ of the base material layer at an applied voltage of 500 V is preferably, for example, 6.5 log Ω·cm or more and 11.0 log Ω·cm or less.

The volume resistivity ρv2₅₀₀ of the surface layer at an applied voltage of 500 V is preferably, for example, 8.0 log Ω·cm or more and 12.0 log Ω·cm or less.

From the viewpoint of further improving the image transfer performance and the recording medium transport performance, in the base material layer, the difference (ρv1₁₀₀−ρv1₅₀₀) between the volume resistivity ρv1₁₀₀ at an applied voltage of 100 V and the volume resistivity ρv1₅₀₀ at an applied voltage of 500 V is preferably, for example, 1.2 or less, and more preferably, 1.0 or more and 1.2 or less.

Aspects

In the belt according to the present disclosure, the thickness of the surface layer with respect to the total thickness of the belt is preferably, for example, 0.6% or more and 3.0% or less, more preferably, 0.6% or more and 2.5% or less, and further preferably, 0.6% or more and 2.0% or less.

In the belt according to the present disclosure, for example, it is preferable that the volume resistivity ρv1₅₀₀ of the base material layer at an applied voltage of 500 V is smaller than volume resistivity ρv2₅₀₀ of the surface layer at an applied voltage of 500 V and that the thickness of the surface layer with respect to the total thickness of the belt is 3.0% or more and 3% or less.

In the belt according to the present disclosure, for example, it is preferable that the difference (ρv1₁₀₀−ρv1₅₀₀) between the volume resistivity ρv1₁₀₀ at an applied voltage of 100 V and the volume resistivity ρv1₅₀₀ at an applied voltage of 500 V in the base material layer is 1.2 or less and that the thickness of the surface layer with respect to the total thickness of the belt is 0.6% or more and 3.0% or less.

In the belt according to the present disclosure, for example, it is preferable that the volume resistivity ρv1₅₀₀ of the base material layer at an applied voltage of 500 V is smaller than the volume resistivity ρv2₅₀₀ of the surface layer at an applied voltage of 500 V and that the difference (ρv1₁₀₀−ρv1₅₀₀) between the volume resistivity ρv1₁₀₀ at an applied voltage of 100 V and the volume resistivity ρv1₅₀₀ at an applied voltage of 500 V in the base material layer is 1.2 or less.

Measurement Method

Hereinafter, methods for measuring the surface resistivity and the volume resistivity will be described.

In each of the belt, the base material layer, and the surface layer according to the present disclosure, measurement points are a total of 18 points of 6 points at equal intervals in a circumferential direction of the belt or each layer and 3 points at the central portion and both end portions in a width direction of the belt or each layer. The arithmetic mean value of these 18 measured values is adopted.

The measurement of the surface resistivity of the belt according to the present disclosure is performed as follows.

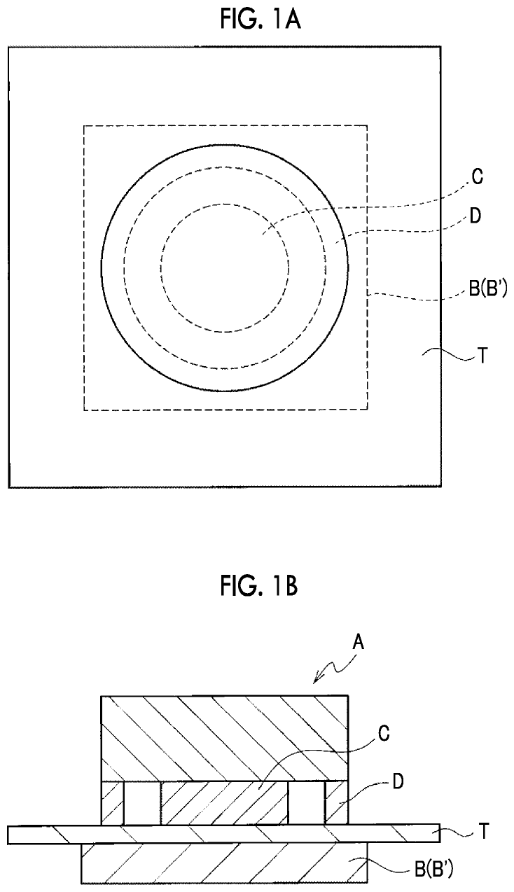

A circular electrode (for example, “UR Probe” of Hiresta IP manufactured by Mitsubishi Yuka Co., Ltd.) is used to perform measurement according to JIS K 6911:1995. A method for measuring the surface resistivity will be described using the drawing. FIGS. 1A and 1B are a schematic plan view and a schematic cross-sectional view showing an example of a circular electrode. The circular electrode shown in FIGS. 1A and 1B includes a first voltage applying electrode A and a plate-like insulator B. The first voltage applying electrode A includes a columnar electrode part C, and a cylindrical ring-shaped electrode part D having an inner diameter larger than the outer diameter of the columnar electrode part C and surrounding the columnar electrode part C with a constant interval therebetween. A current I (A) flowing when a belt T is clamped between the columnar electrode part C and the ring-shaped electrode part D of the first voltage applying electrode A and the plate-like insulator B and a voltage V (V) is applied between the columnar electrode part C and the ring-shaped electrode part D of the first voltage applying electrode A is measured, and surface resistivity ρs (Ω/□) of the transport and transferring surface of the belt is calculated by the following expression. Here, in the following expression, d (mm) indicates the outer diameter of the columnar electrode part C, and D (mm) indicates the inner diameter of the ring-shaped electrode part D.

ρs=π×(D+d)/(D−d)×(V/I) Expression:

The surface resistivity is calculated by obtaining a current value after application of a voltage of 100 V or 500 V for 10 seconds under the environment of 22° C./55% RH by using a circular electrode (UR probe of Hiresta IP manufactured by Mitsubishi Yuka Co., Ltd.: outer diameter Φ16 mm of the columnar electrode part C, and inner diameter Φ30 mm and outer diameter Φ40 mm of the ring-shaped electrode part D).

On the other hand, the measurement of the volume resistivity of the belt, the base material layer, and the surface layer according to the present disclosure is performed as follows.

A circular electrode (for example, UR Probe of Hiresta IP manufactured by Mitsubishi Yuka Co., Ltd.) is used to perform measurement according to JIS K 6911:1995. A method for measuring the volume resistivity will be described using FIGS. 1A and 1B. The measurement is performed with the same device as that in the surface resistivity. However, in the circular electrode shown in FIGS. 1A and 1B, a second voltage applying electrode B′ is provided in place of the plate-like insulator B used when measuring the surface resistivity. Then, a current I (A) flowing when a belt T is clamped between the columnar electrode part C and the ring-shaped electrode part D of the first voltage applying electrode A and the second voltage applying electrode B′ and a voltage V (V) is applied between the columnar electrode part C and the second voltage applying electrode B in the first voltage applying electrode A is measured, and volume resistivity ρv (Ωcm) of the belt T is calculated by the following expression. Here, in the following expression, t indicates the thickness of the measurement sample (that is, the belt, the base material layer, or the surface layer).

ρv=19.6×(V/I)×t Expression:

The volume resistivity is calculated by obtaining a current value after application of a voltage of 100 V or 500 V for 10 seconds under the environment of 22° C./55% RH by using a circular electrode (UR probe of Hiresta IP manufactured by Mitsubishi Yuka Co., Ltd.: outer diameter Φ16 mm of the columnar electrode part C, and inner diameter Φ30 mm and outer diameter Φ40 mm of the ring-shaped electrode part D).

19.6 shown in the above expression is an electrode coefficient for conversion to resistivity, and is calculated as πd²/4t from the outer diameter d (mm) of the columnar electrode part and the thickness t (cm) of the measurement sample.

Further, the thicknesses of the belt, the base material layer, and the surface layer, which are measurement samples, are all measured using an eddy current type thickness meter CTR-1500E manufactured by Sanko Electronics Co., Ltd. At this time, the thickness is measured at any one position.

As described above, since the measurement points (that is, the number of measurement samples) are 18 points, the arithmetic mean value of the thicknesses of the 18 measurement samples can also be set to be the total thickness of the belt, the thickness of the base material layer, or the thickness of the surface layer.

In a case of determining the thicknesses of the base material layer and the surface layer from the belt, either the surface layer or the base material layer is polished with a polishing tool such as a file having an extra fine or finer mesh with reference to the thickness of each layer in a cross section portion measured by cross section observation, and cut to obtain a measurement sample. Then, the thickness, volume resistivity, and the like of the obtained measurement sample (base material layer or surface layer measurement sample) may be measured by the methods described above.

The surface resistivity and volume resistivity of the belt according to the present disclosure and the base material layer and surface layer configuring the belt are controlled according to the type of conductive particles, the type of conductive agent, the amount of addition thereof, or the like.

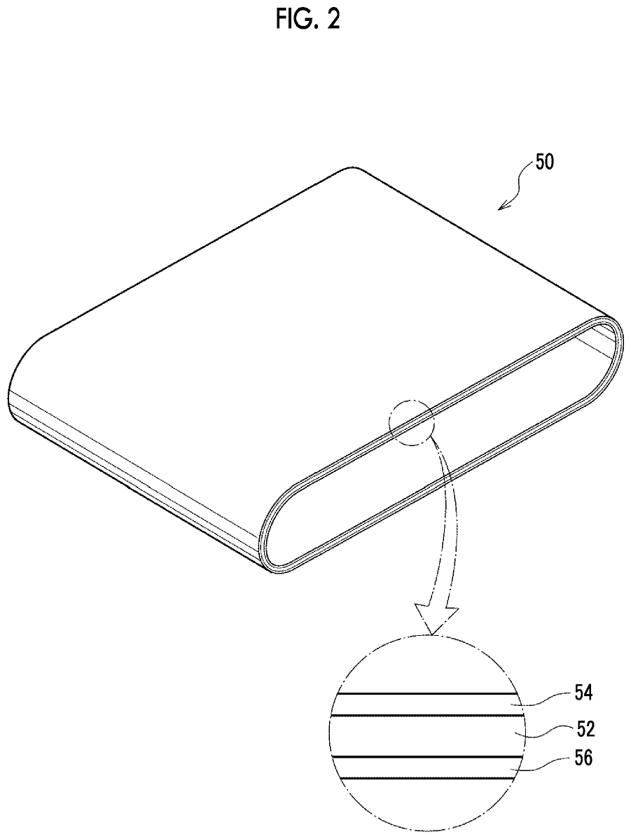

Hereinafter, the belt according to the present disclosure will be described with reference to FIG. 2. Here, FIG. 2 is a schematic perspective view showing an example of the belt according to the present disclosure.

As shown in FIG. 2, a belt 50 has a base material layer 52, a surface layer 54, and a back layer 56. The surface layer 54 is a layer provided on the outer peripheral surface of the base material layer 52 and configuring the outer peripheral surface of the belt 50. The back layer 56 is a layer provided on the inner peripheral surface of the base material layer 52 and configuring the inner peripheral surface of the belt 50.

The outer peripheral surface of the belt 50 is also called the surface of the belt and corresponds to a transport surface for a recording medium. The surface resistivity of the belt refers to the surface resistivity of the outer peripheral surface of the belt 50, that is, the surface configured by the surface layer 54.

In FIG. 2, a layer configuration provided with the back layer 56 is shown. However, the back layer may be omitted.

Base Material Layer

The base material layer is preferably, for example, a belt-like member in which conductive particles are contained in a polymer material. The base material layer may contain an additive, as necessary, in addition to the polymer material and the conductive particles.

As the polymer material, rubber or resin can be given as an example.

As the polymer material, one kind may be used alone, or two or more kinds may be used in combination.

As the rubber, chloroprene rubber, epichlorohydrin rubber, isoprene rubber, butyl rubber, polyurethane, silicone rubber, fluororubber, styrene-butadiene rubber, butadiene rubber, nitrile rubber (NBR), ethylene propylene rubber, ethylene-propylene-diene ternary copolymer rubber (EPDM), natural rubber, or mixed rubber thereof can be given as an example.

As the resin, polyamide, polyimide, polyamide imide, polyether imide, polyether ether ketone, polyphenylene sulfide, polyether sulfone, polyphenyl sulfone, polysulfone, polyethylene terephthalate, polybutylene terephthalate, polyacetal, polycarbonate, polyester, or mixed resin thereof can be given as an example.

As the conductive particles, carbon black such as Ketjen black, oil furnace black, channel black, or acetylene black; metal particles such as aluminum or nickel; metal oxide particles such as indium tin oxide, tin oxide, zinc oxide, titanium oxide, or yttrium oxide; or the like can be given as an example. As the conductive particles, among these, for example, carbon black is preferable.

As the conductive particles, one kind may be used alone, or two or more kinds may be used in combination.

The average primary particle size of the conductive particles (preferably, for example, carbon black) is preferably, for example, 1 nm or more and 500 nm or less, more preferably, 5 nm or more and 200 nm or less, and further preferably, 10 nm or more and 100 nm or less.

The base material layer may contain a conductive agent other than the conductive particles.

As the conductive agent, an ion conductive substance such as potassium titanate, potassium chloride, sodium perchlorate, or lithium perchlorate; an ion conductive polymer such as polyaniline, polyether, polypyrrole, polysulfone, or polyacetylene; or the like can be given as an example.

As the conductive agent other than the conductive particles, one kind may be used alone, or two or more kinds may be used in combination.

The base material layer is preferably, for example, a conductive elastic layer that contains rubber and conductive particles, and more preferably, for example, a conductive elastic layer that contains at least one of chloroprene rubber or epichlorohydrin rubber, and carbon black.

The total content of the conductive particles and the conductive agent which are contained in the base material layer is set preferably, for example, based on the volume resistivity of the belt described above.

In a case where the base material layer contains carbon black, the content of carbon black is preferably, for example, 5 parts by mass or more and 40 parts by mass or less with respect to 100 parts by mass of the polymer material.

The base material layer may further contain an additive such as a vulcanization agent, a vulcanization assistant, a vulcanization accelerator, a cross-linking agent, an antioxidant, a flame retardant, a colorant, a surfactant, a dispersant, or a filler.

Resistivity can be adjusted by using, for example, a filler having insulation properties or semi-conductivity, such as zinc oxide or magnesium oxide, as the additive.

From the viewpoint of the durability of the belt, the average thickness of the base material layer is preferably, for example, 50 μm or more, more preferably, 75 μm or more, and further preferably, 100 μm or more, and from the viewpoint of flexibility and bending resistance of the belt, the average thickness of the base material layer is preferably, for example, 1000 μm or less, more preferably, 700 μm or less, and further preferably, 500 μm or less.

Surface Layer and Back Layer

The surface layer is a layer that is provided on the outer peripheral surface of the base material layer and configures the outer peripheral surface of the belt. The back layer is a layer that is provided on the inner peripheral surface of the base material layer and configures the inner peripheral surface of the belt.

Hereinafter, the surface layer and the back layer will be described.

Both the surface layer and the back layer are preferably, for example, layers containing a polymer material.

As the polymer material, the rubber or the resin described above with respect to the base material layer can be given as an example.

Each of the surface layer and the back layer contains preferably, for example, urethane resin and fluorine-containing resin particles.

The urethane resin (also called polyurethane or urethane rubber) is generally synthesized by polymerizing polyisocyanate and polyol. The urethane resin has preferably, for example, a hard segment and a soft segment.

As the fluorine-containing resin particles, for example, one kind or two or more kinds of particles composed of any of ethylene tetrafluoride resin, ethylene trifluoride chloride resin, propylene hexafluoride resin, vinyl fluoride resin, vinylidene fluoride resin, ethylene difluoride dichloride resin, and copolymer thereof are preferable. Among the resins, as the fluorine-containing resin particles, for example, ethylene tetrafluoride resin particles are preferable.

The average primary particle size of the fluorine-containing resin particles is preferably, for example, 10 nm or more and 500 nm or less, more preferably, for example, 50 nm or more and 300 nm or less, and further preferably, for example, 80 nm or more and 200 nm or less, for example.

Each of the surface layer and the back layer may further contain an additive such as an antioxidant, a cross-linking agent, a flame retardant, a colorant, or a filler.

From the viewpoint of durability of the belt, the average thickness of each of the surface layer and the back layer is preferably, for example, 0.1 μm or more, more preferably, 0.5 μm or more, and further preferably, 1 μm or more, and from the viewpoint of flexibility and bending resistance of the belt, the average thickness of each of the surface layer and the back layer is preferably, for example, 50 μm or less, more preferably, 20 μm or less, and further preferably, m or less.

The compositions of the surface layer and the back layer may be the same or different from each other.

The thicknesses of the surface layer and the back layer may be the same or different from each other.

Method for Manufacturing Belt

As a method for manufacturing the belt according to the present disclosure, a manufacturing method in which a tubular member to become a base material layer is prepared and a surface layer is formed on the outer peripheral surface of the tubular member can be given as an example. Further, a back layer may be formed on the inner peripheral surface of the tubular member.

A method for manufacturing the tubular member is, for example, extrusion molding in which a composition containing a polymer material and conductive particles is melted and extruded from a dice into a belt shape and then solidified; injection molding in which a composition containing a polymer material and conductive particles is melted and put in a belt-shaped mold and then solidified; coating molding in which a composition containing a precursor or monomer of a polymer material and conductive particles is applied to a core body and solidified; or the like. Heating for the purpose of vulcanization of rubber may be performed at an appropriate time in the molding process.

A method for forming the surface layer and the back layer includes, for example, applying a liquid composition containing a polymer material and fluorine-containing resin particles to the outer peripheral surface or the inner peripheral surface of the tubular member and solidifying the liquid composition; applying a liquid composition containing a precursor or a monomer of a polymer material and fluorine-containing resin particles to the outer peripheral surface or the inner peripheral surface of the tubular member and solidifying the liquid composition; or the like. In order to solidify the liquid composition, drying, heating, electron beam irradiation, or ultraviolet irradiation may be performed according to the type of the component.

Belt Unit

The belt unit according to the present disclosure includes a recording medium transport and transfer belt, and a plurality of rolls around which the recording medium transport and transfer belt is wound in a tensioned state, in which at least one of the plurality of rolls is a drive roll that rotates the recording medium transport and transfer belt, and the belt unit is mounted to and demounted from an image forming apparatus. Here, as the recording medium transport and transfer belt, the above-described belt according to the present disclosure is applied.

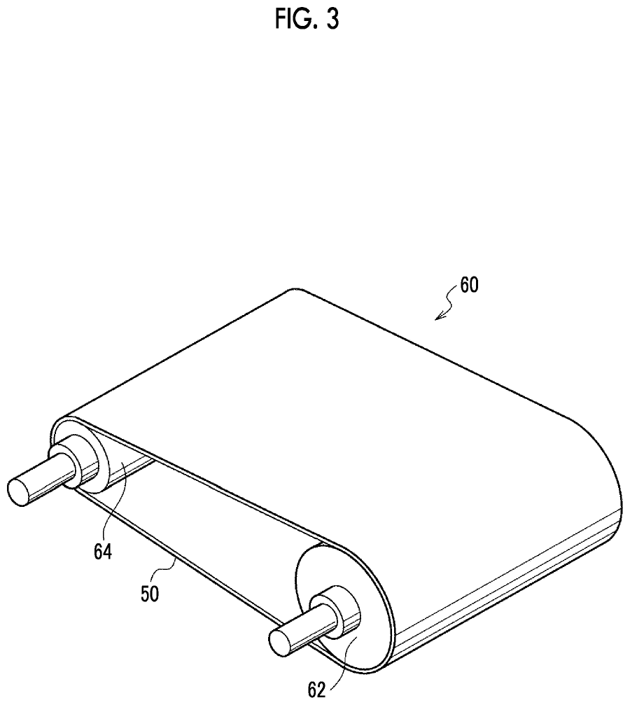

FIG. 3 is a schematic perspective view showing an example of the belt unit according to the present disclosure. Here, FIG. 3 is a schematic perspective view showing a state where the recording medium transport and transfer belt is wound around a plurality of roll members.

As shown in FIG. 3, a belt unit 60 includes the recording medium transport and transfer belt 50, a drive roll 62, and a support roll 64, and has a form in which the recording medium transport and transfer belt 50 is wound around the drive roll 62 and the support roll 64 in a tensioned state (also called a “stretched form” in the present disclosure).

The drive roll 62 is rotated by the power of a driving unit (not shown) connected to the drive roll 62. The recording medium transport and transfer belt 50 and the support roll 64 rotate in accordance with the rotation of the drive roll 62.

The belt unit 60 is used by being incorporated into an electrophotographic image forming apparatus as a part of a transfer unit. The belt unit 60 is suitable for, for example a secondary transfer belt unit. In the belt unit, the number of roll members around which the recording medium transport and transfer belt is stretched is not limited to two, and may be three or more.

Image Forming Apparatus

An image forming apparatus according to the present disclosure includes an image carrier, a charging unit that charges the surface of the image carrier, an electrostatic charge image forming unit that forms an electrostatic charge image on the charged surface of the image carrier, a developing unit that accommodates a developing agent containing toner and develops the electrostatic charge image formed on the surface of the image carrier by using the developing agent to form a toner image, and a transfer unit having the belt unit according to the present disclosure and transferring the toner image to a recording medium. The transfer unit includes, for example, an intermediate transfer body, a primary transfer unit that transfers the toner image to the surface of the intermediate transfer body, and a secondary transfer unit that transfers the toner image transferred to the surface of the intermediate transfer body to the recording medium, and the secondary transfer unit has the belt unit according to the present disclosure.

The image forming apparatus according to the present disclosure may further include a fixing unit that fixes the toner image transferred to the surface of the recording medium, an image carrier cleaner that cleans the surface of the image carrier after the transfer of the toner image and before charging, a static elimination unit that irradiates the surface of the image carrier with static elimination light after transfer of the toner image and before charging to eliminate static electricity, and the like. In the image forming apparatus according to the present disclosure, the portion including the developing unit may have a cartridge structure (process cartridge) which is mounted to and demounted from the image forming apparatus.

Hereinafter, an example of the image forming apparatus according to the present disclosure will be described. However, there is no limitation to this example. In the following description, principal parts shown in the drawing will be described, and the description of other parts will be omitted.

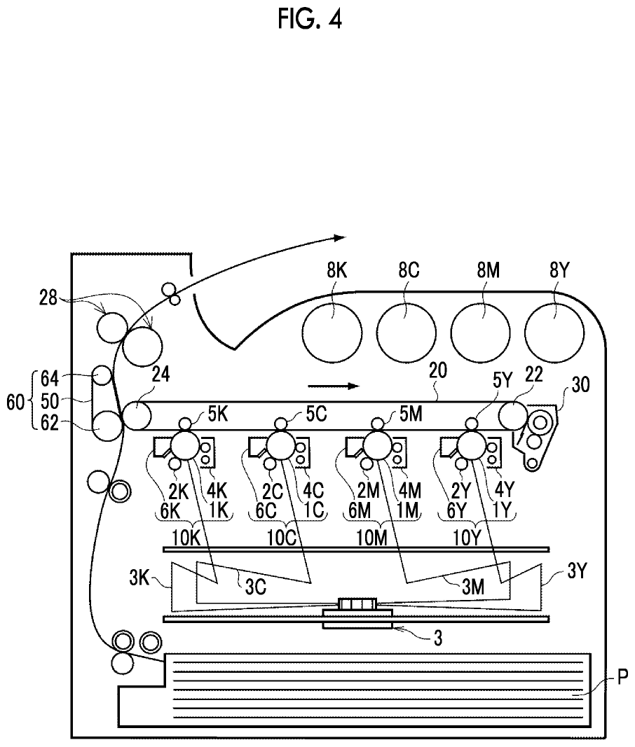

FIG. 4 is a schematic configuration diagram showing an example of the image forming apparatus according to the present disclosure.

The image forming apparatus shown in FIG. 4 includes first to fourth electrophotographic image forming units 10Y, 10M, 10C, and 10K (image forming units) that output images of each colors of yellow (Y), magenta (M), cyan (C), and black (K), based on color-separated image data. The image forming units (hereinafter, there is a case of being simply referred to as “units”) 10Y, 10M, 10C, and 10K are arranged side by side to be separated at a predetermined distance from each other in the horizontal direction. The units 10Y, 10M, 10C, and 10K may be process cartridges that are mounted to and demounted from the image forming apparatus.

An intermediate transfer belt (an example of an intermediate transfer body) 20 is provided above the units 10Y, 10M, 10C, and 10K to extend through each unit. The intermediate transfer belt 20 is provided by being wound around a drive roll 22 and a support roll 24 that are in contact with the inner surface of the intermediate transfer belt 20, and travels in the direction from the first unit 10Y toward the fourth unit 10K. The support roll 24 is applied with a force in the direction away from the drive roll 22 by a spring (not shown) or the like, so that tension is applied to the intermediate transfer belt 20 wound around the drive roll 22 and the support roll 24. An intermediate transfer belt cleaning device 30 is provided on the image holding surface side of the intermediate transfer belt 20 so as to face the drive roll 22.

Each toner of yellow, magenta, cyan, and black contained in toner cartridges 8Y, 8M, 8C, and 8K is supplied to each of developing devices (each is an example of a developing unit) 4Y, 4M, 4C, and 4K of the units 10Y, 10M, 10C, and 10K.

Since the first to fourth units 10Y, 10M, 10C, and 10K have the same configuration and operation, here, the first unit 10Y forming a yellow image and disposed on the upstream side in a traveling direction of the intermediate transfer belt will be described as a representative.

The first unit 10Y includes a photoconductor 1Y (an example of the image carrier). A charging roll (an example of a charging unit) 2Y that charges the surface of the photoconductor 1Y to a potential determined in advance, an exposure device (an example of an electrostatic charge image forming unit) 3 that exposes the charged surface with a laser beam 3Y based on a color-separated image signal to form an electrostatic charge image, a developing device (an example of a developing unit) 4Y that develops the electrostatic charge image by supplying charged toner to the electrostatic charge image, a primary transfer roll (an example of a primary transfer unit) 5Y that transfers the developed toner image onto the intermediate transfer belt 20, and a photoconductor cleaning device 6Y that removes the toner remaining on the surface of the photoconductor 1Y after the primary transfer are disposed in order around the photoconductor 1Y.

The primary transfer roll 5Y is disposed inside the intermediate transfer belt 20 and is provided at a position facing the photoconductor 1Y A bias power source (not shown) for applying a primary transfer bias is connected to each of the primary transfer rolls 5Y, 5M, 5C, and 5K of the units.

The belt unit 60 is a belt unit provided with the recording medium transport and transfer belt 50 (an example of the recording medium transport and transfer belt according to the present disclosure). The belt unit 60 includes the recording medium transport and transfer belt 50, the drive roll 62, and the support roll 64. The belt unit 60 is disposed outside the intermediate transfer belt 20 and is provided at a position facing the support roll 24. A bias power source (not shown) for applying a secondary transfer bias is connected to the belt unit 60.

Hereinafter, the operation of forming a yellow image in the first unit 10Y will be described.

First, prior to the operation, the surface of the photoconductor 10Y is charged to a potential in the range of −600 V to −800 V by the charging roll 2Y The photoconductor 1Y is formed by laminating a photosensitive layer on a conductive substrate (having, for example, a volume resistivity at 20° C. of 1×10⁻⁶ Ωcm or less). The photosensitive layer usually has high resistance (resistance of a general resin). However, the photosensitive layer has a property that in a case where the photosensitive layer is irradiated with a laser beam, the specific resistance of the portion irradiated with the laser beam changes. Therefore, the surface of the charged photoconductor 1Y is irradiated with the laser beam 3Y from the exposure device 3 according to the image data for yellow, which is sent from a control unit (not shown). In this way, an electrostatic charge image having a yellow image pattern is formed on the surface of the photoconductor 1Y.

The electrostatic charge image is an image that is formed on the surface of the photoconductor 1Y by charging, and is a so-called negative latent image that is formed due to the specific resistance of the irradiated portion of the photosensitive layer being lowered by the laser beam 3Y and the charged electric charges on the surface of the photoconductor 1Y flowing, and on the other hand, the electric charges of the portion not irradiated with the laser beam 3Y remaining.

The electrostatic charge image formed on the photoconductor 1Y rotates to a developing position determined in advance, according to the traveling of the photoconductor 1Y Then, at the developing position, the electrostatic charge image on the photoconductor 1Y is developed and visualized as a toner image by the developing device 4Y.

For example, an electrostatic charge image developing agent containing at least a yellow toner and a carrier is accommodated in the developing device 4Y The yellow toner is triboelectrically charged by being agitated inside the developing device 4Y, has an electrostatic charge having the same polarity (negative polarity) as the charged electric charge on the photoconductor 1Y, and is held on a developing agent roll (an example of a developing agent holder). Then, the surface of the photoconductor 1Y passes through the developing device 4Y, so that the yellow toner is electrostatically stuck to the statically eliminated latent image portion on the surface of the photoconductor 1Y, and the latent image is developed by the yellow toner. The photoconductor 1Y on which the yellow toner image is formed is continuously traveled at a speed determined in advance, and the developed toner image on the photoconductor 1Y is transported to a primary transfer position determined in advance.

In a case where the yellow toner image on the photoconductor 1Y is transferred to the primary transfer position, a primary transfer bias is applied to the primary transfer roll 5Y, and an electrostatic force from the photoconductor 1Y toward the primary transfer roll 5Y acts on the toner image, and the toner image on the photoconductor 1Y is transferred onto the intermediate transfer belt 20. The transfer bias that is applied at this time has a (+) polarity opposite to the polarity (−) of the toner, and is controlled to, for example, +10 μA by a control unit (not shown) in the first unit 10Y.

The primary transfer bias that is applied to the primary transfer rolls 5M, 5C, and 5K of the second unit 10M and the subsequent units is also controlled in accordance with to the first unit.

In this way, the intermediate transfer belt 20 to which the yellow toner image is transferred in the first unit 10Y is sequentially transported through the second to fourth units 10M, 10C, and 10K, and the toner images of the respective colors are superimposed, and thus multiple transfer is performed.

The intermediate transfer belt 20 to which the toner images of four colors are multiple-transferred through the first to fourth units reaches a secondary transfer unit composed of the intermediate transfer belt 20, the support roll 24, and the belt unit 60. On the other hand, recording paper (an example of the recording medium) P is fed to the gap where the belt unit 60 and the intermediate transfer belt 20 are in contact with each other via a supply mechanism at a timing determined in advance, and the secondary transfer bias is applied to the support roll 24. The transfer bias that is applied at this time has a (−) polarity that is the identical polarity to the toner polarity (−), and the electrostatic force from the intermediate transfer belt 20 toward the recording paper P acts on the toner image, and the toner image on the intermediate transfer belt 20 is transferred onto the recording paper P. The secondary transfer bias at this time is determined according to the resistance detected by a resistance detection unit (not shown) that detects the resistance of the secondary transfer unit, and is controlled in voltage.

The recording paper P with the toner image transferred thereto is sent to a pressure contact portion (nip portion) of a pair of fixing rolls of a fixing device (an example of a fixing unit) 28, the toner image is fixed to the recording paper P, and a fixed image is formed. The recording paper P on which the fixing of the color image has been completed is carried out toward a discharge unit, and a series of color image forming operations is ended.

As the recording paper P to which the toner image is transferred, plain paper that is used in electrophotographic copying machines, printers, or the like can be given as an example. As the recording medium, in addition to the recording paper P, an OHP sheet or the like can be given as an example.

### EXAMPLES

Hereinafter, the present exemplary embodiment will be more specifically described by illustrating examples. However, the present exemplary embodiment is not limited to the following examples. Unless otherwise specified, synthesis, treatment, production, and the like are performed at room temperature (24° C.±3° C.). In the following description, unless otherwise specified, “parts” and “%” are all based on mass.

### Example 1

Fabrication of Base Material Layer

The following rubber composition 1 is prepared.

Rubber Composition 1
Chloroprene rubber (CR) (Tosoh Corp., TSR-61) 80 parts
Ethylene-propylene-diene rubber (EPDM) (Sumitomo Chemical Co., Ltd., Esplen 505) 20 parts
Carbon black (Mitsubishi Chemical Corp., #3030B) 25 parts
Sulfur (Bayer, Renogran S-80) 1 part
Zinc oxide (Bayer, Renogran ZnO-80) 6 parts
Magnesium oxide (Kyowa Chemical Industry Co., Ltd., Kyowa Mag 150) 4 parts
Vulcanization accelerator (Ouchi Shinko Chemical Industry Co., Ltd., Noxeller M) 1 part
Stearic acid 0.5 parts

More specifically, a mixture containing chloroprene rubber and carbon black is mixed with ethylene-propylene-diene rubber, and another material is further added to the mixture. The mixture is placed IN and extruded BY a kneading extruder, dried with hot air, and further heated for vulcanization to obtain a tubular member having a diameter (outer diameter) of 40 mm and an average thickness of 450 μm. The tubular member is cut to a length of 355 mm to obtain a base material layer A.

Fabrication of Surface Layer and Back Layer

1% by mass of a curing agent (Loctite WH-1, Henkel Japan Ltd.) is added to a PTFE (polytetrafluoroethylene)-containing urethane resin (Bonderite T862A, Henkel Japan Ltd.) and diluted with water to adjust the amount of PTFE to 10% by mass, and the obtained mixture is used as a coating liquid.

A coating liquid is sprayed onto the outer peripheral surface of the base material layer Awhile rotating the base material layer A with the central axis of the base material layer A being in the horizontal direction. Next, hot air drying is performed at a temperature of 150° C. for 35 minutes to form a surface layer. The average thickness of the surface layer is set to 6 μm. Next, the same coating liquid is also sprayed onto the inner peripheral surface of the base material layer A, and hot air drying is performed in the same manner to form a back layer. The average thickness of the back layer is set to 6 km.

In this way, an endless belt is obtained.

### Example 2

An endless belt is obtained in the same manner as in Example 1 except that the amount of the carbon black is changed to 18 parts in the fabrication of the base material Layer A.

### Example 3

An endless belt is obtained in the same manner as in Example 1 except that the amount of the carbon black is changed to 15 parts, the amount of the chloroprene rubber is changed to 85 parts, and the amount of the ethylene-propylene-diene rubber is changed to 15 parts in the fabrication of the base material Layer A.

### Examples 4 and 5

An endless belt is obtained in the same manner as in Example 1 except that the thickness of the base material layer is changed by polishing the surface of the tubular member obtained after vulcanization with a polishing machine over the entire circumference from the surface in the fabrication of the base material Layer A.

### Examples 6 and 7

An endless belt is obtained in the same manner as in Example 1 except that the thickness of the base material layer is changed by polishing the surface of the tubular body after vulcanization with a polishing machine over the entire circumference from the surface in the fabrication of the base material Layer A and the thickness of the surface layer is changed by adjusting the amount of the coating liquid that is sprayed onto the outer peripheral surface of the base material layer A in the fabrication of the surface layer.

### Comparative Example 1

An endless belt is obtained in the same manner as in Example 1 except that the amount of the chloroprene rubber is changed to 75 parts and the amount of the ethylene-propylene-diene rubber is changed to 25 parts in the fabrication of the base material layer A.

### Comparative Example 2

An endless belt is obtained in the same manner as in Example 1 except that the amount of the chloroprene rubber is changed to 75 parts, the amount of the ethylene-propylene-diene rubber is changed to 25 parts, and the amount of the carbon black is changed to 15 parts in the fabrication of the base material layer A.

### Comparative Example 3

An endless belt is obtained in the same manner as in Example 1 except that the amount of the chloroprene rubber is changed to 70 parts and the amount of the ethylene-propylene-diene rubber is changed to 30 parts in the fabrication of the base material layer A.

### Comparative Example 4

An endless belt is obtained in the same manner as in Example 1 except that the amount of the chloroprene rubber is changed to 70 parts, the amount of the ethylene-propylene-diene rubber is changed to 30 parts, and the amount of the carbon black is changed to 15 parts in the fabrication of the base material layer A.

### Comparative Example 5

An endless belt is obtained in the same manner as in Example 1 except that in the preparation of the base material, the amount of chloroprene rubber is changed to 75 parts, the amount of ethylene-propylene-diene rubber is changed to 25 parts, and the amount of the carbon black is changed to 23 parts in the fabrication of the base material layer A.

### Comparative Example 6

An endless belt is obtained in the same manner as in Example 1 except that the amount of the chloroprene rubber is changed to 85 parts, the amount of the ethylene-propylene-diene rubber is changed to 15 parts, and the amount of the carbon black is changed to 23 parts in the fabrication of the base material layer A.

Various Measurements

The surface resistivity ρs₅₀₀ and ρs₁₀₀ and the volume resistivity ρv₅₀₀ of the belt are measured according to the methods described above.

Further, the volume resistivity ρv1₅₀₀ of the base material layer and the volume resistivity ρv2₅₀₀ of the surface layer are measured and the volume resistivity ρv1₁₀₀ of the base material layer is also measured, according to the methods described above.

The ratio (ρs₅₀₀/ρv₅₀₀) between the surface resistivity ρs₅₀₀ and the volume resistivity ρv₅₀₀ at an applied voltage of 500 V, the difference (ρs₁₀₀−ρs₅₀₀) between the surface resistivity ρs₁₀₀ at an applied voltage of 100 V and the surface resistivity ρs₅₀₀ at an applied voltage of 500 V, and the difference (ρv1₁₀₀−ρv1₅₀₀) between the volume resistivity ρv1₁₀₀ at an applied voltage of 100 V and the volume resistivity ρv1₅₀₀ at an applied voltage of 500 V in the base material layer are obtained based on the above measurement results.

The results are shown in Table 1.

Belt Performance Evaluation

A secondary transfer unit is fabricated by using the endless belt obtained in each example for a recording medium transport and transfer belt. The secondary transfer unit is mounted to a modified machine of an image forming apparatus DocuColor-7171P (FUJIFILM Business Innovation Corp.) to obtain an image forming apparatus. A guide for recording medium transport is mounted to an end portion of the secondary transfer belt, and the transport speed of the recording medium is adjusted to be constant.

Transport Performance

The transport performance of the recording medium transport and transfer belt is affected by a local tension difference of the belt and a speed fluctuation with rotation. Therefore, the transport performance of the endless belt obtained in each example is evaluated by the following method.

The endless belt is continuously rotationally driven in a state where the endless belt is stretched with a stretch ratio of 4% by a stretching roll. The rotation speed of the rotational driving is set to 540 mm/s, and the driving time is set to 120 hours. The rotation is stopped after the rotational driving, a damaged state, such as scratches on the end portion of the endless belt and scratches on the outer peripheral surface of the endless belt, and the position of the end portion of the endless belt are confirmed, and the transport performance is evaluated according to the following indexes.

Evaluation Indexes
G1 (A): Belt walk is within a control aim range.
G2 (B): Belt walk is outside a control aim range but within an operating limit range.
G3 (C): Belt walk is outside an operating limit range and damage to the belt also occurs.

Transfer Performance

10 pieces of halftone images each having an image density of 20% are continuously formed on a recording medium (paper, A3 size, basis weight: 82 g/m₂, thickness: 97 μm) by using the image forming apparatus described above. The last tenth image is visually observed, and the transfer performance is evaluated according to the following indexes.

Evaluation indexes
G1 (A): No color unevenness and color loss are recognized.
G2 (B): Minor color unevenness is recognized. However, the level is acceptable for practical use.
G3 (C): Color unevenness and color loss are partially recognized.

Maintainability

In order to secure stable image quality, the recording medium transport and transfer belt is required to maintain the cleanness and surface properties of the outer peripheral surface even when subjected to a change in elongation with rotational movement, or a fluctuation in external load, and environmental influences. Visual observation of an image, and the surface state of the outer peripheral surface of the endless belt are confirmed by the following methods, and the maintainability is evaluated according to the following indexes.

After the operation of forming a halftone image with an image density of 5% on a recording medium (paper, A3 size, basis weight: 82 g/m², thickness: 97 μm) and transporting the recording medium is continuously performed 10,000 times by using the image forming apparatus described above, 10 pieces of halftone images with an image density of 20% are formed on the recording medium, and the tenth image is visually observed. Further, the endless belt after image formation is removed from the image forming apparatus, and the outer peripheral surface of the endless belt is observed visually or at a magnification of 100 times using a CCD camera to confirm the surface state (the presence or absence of foreign matter). Based on these, the maintainability is evaluated according to the following indexes.

Evaluation Indexes

G1 (A): Color unevenness and color loss are not recognized in the image, and adhesion of foreign matter to the surface of the endless belt is not recognized even by visual observation and magnified observation.
G2 (B): Minor color unevenness is recognized in the image. Adhesion of foreign matter to the surface of the endless belt is not observed.
LG (C): Foreign matter that is recognized by magnified observation is present on the surface of the endless belt, or color unevenness and color loss are partially recognized in the image.

TABLE 1

| | Belt | | | | | | | | |
|---|---|---|---|---|---|---|---|---|---|
| | | | | Differ- | Total | Base material layer | | | |
| | Volume | Surface | Ratio | ence | thick- | Volume | | Difference | |
| | resistivity | resistivity | (ρs₅₀₀/ | (ρs₁₀₀ − | ness | resistivity | Thick- | (ρv1₁₀₀ − | |
| | ρv₅₀₀ | ρv₅₀₀ | ρv₅₀₀) | ρs₅₀₀) | X | ρv1₅₀₀ | ness | pv1₅₀₀) | |
| | [LogΩ · cm] | [LogΩ/□] | [—] | [—] | [μm] | [LogΩ · cm] | [μm] | [—] | |
| Example 1 | 9.2 | 11.0 | 1.20 | 0.20 | 462 | 7.26 | 450 | 1.00 | ∘ |
| Example 2 | 9.5 | 9.6 | 1.02 | 0.27 | 462 | 8.70 | 450 | 1.20 | ∘ |
| Example 3 | 10.3 | 12.7 | 1.24 | 0.20 | 462 | 10.24 | 450 | 1.64 | x |
| Example 4 | 9.4 | 10.9 | 1.17 | 0.25 | 452 | 7.64 | 440 | 1.13 | ∘ |
| Example 5 | 9.4 | 10.9 | 1.17 | 0.25 | 442 | 7.64 | 430 | 1.24 | x |
| Example 6 | 9.4 | 10.8 | 1.15 | 0.22 | 447 | 7.64 | 440 | 1.13 | ∘ |
| Example 7 | 9.4 | 10.6 | 1.13 | 0.23 | 461 | 7.64 | 440 | 1.13 | ∘ |
| Comparative | 9.6 | 9.2 | 0.96 | 0.28 | 462 | 7.67 | 450 | 0.90 | ∘ |
| Example 1 | | | | | | | | | |
| Comparative | 10.4 | 10.2 | 0.98 | 0.32 | 462 | 8.60 | 450 | 2.08 | x |
| Example 2 | | | | | | | | | |
| Comparative | 9.9 | 8.8 | 0.89 | 1.75 | 462 | 7.80 | 450 | 1.48 | x |
| Example 3 | | | | | | | | | |
| Comparative | 10.5 | 10.5 | 1.00 | 0.83 | 462 | 8.80 | 450 | 2.05 | x |
| Example 4 | | | | | | | | | |
| Comparative | 9.2 | 10.0 | 1.09 | 0.80 | 462 | 6.86 | 450 | 0.94 | ∘ |
| Example 5 | | | | | | | | | |
| Comparative | 9.4 | 10.4 | 1.11 | 0.60 | 462 | 7.72 | 450 | 1.85 | x |
| Example 6 | | | | | | | | | |

| | Surface layer | | | | | | |
|---|---|---|---|---|---|---|---|
| | Volume | Thick- | | | Evaluation | | |
| | resistivity | ness | ρv1₅₀₀ < | Y/X × | Transport | Transfer | |
| | ρv2₅₀₀ | Y | ρv2₅₀₀ | 100 | perfor- | perfor- | Maintain- |
| | [LogΩ · cm] | [μm] | [—] | [%] | mance | mance | ability |
| Example 1 | 8.88 | 6 | ∘ | 1.3 | G1 | G1 | G1 |
| Example 2 | 8.88 | 6 | ∘ | 1.3 | G1 | G1 | G1 |
| Example 3 | 8.88 | 6 | x | 1.3 | G1 | G2 | G1 |
| Example 4 | 8.88 | 6 | ∘ | 1.33 | G1 | G2 | G1 |
| Example 5 | 8.88 | 6 | ∘ | 1.36 | G1 | G2 | G1 |
| Example 6 | 8.88 | 1 | ∘ | 0.2 | G1 | G2 | G2 |
| Example 7 | 8.88 | 15 | ∘ | 3.4 | G1 | G2 | G2 |
| Comparative | 8.88 | 6 | ∘ | 1.3 | G3 | G3 | G1 |
| Example 1 | | | | | | | |
| Comparative | 8.88 | 6 | ∘ | 1.3 | G3 | G2 | G3 |
| Example 2 | | | | | | | |
| Comparative | 8.88 | 6 | ∘ | 1.3 | G3 | G3 | G2 |
| Example 3 | | | | | | | |
| Comparative | 8.88 | 6 | ∘ | 1.3 | G1 | G2 | G3 |
| Example 4 | | | | | | | |
| Comparative | 8.88 | 6 | ∘ | 1.3 | G2 | G2 | G2 |
| Example 5 | | | | | | | |
| Comparative | 8.88 | 6 | ∘ | 1.3 | G1 | G3 | G2 |
| Example 6 | | | | | | | |

From the results shown in Table 1, it can be seen that the examples are superior in transport performance and transfer performance as compared with the comparative examples.

Hereinafter, aspects of the present invention will be additionally described.

(((1)))

A recording medium transport and transfer belt comprising:
at least a base material layer and a surface layer,
wherein a ratio (ρs₅₀₀/ρv₅₀₀) between surface resistivity ρs₅₀₀ and volume resistivity ρv₅₀₀ at an applied voltage of 500 V is 1.0 or more, and
a difference (ρs₁₀₀−ρs₅₀₀) between surface resistivity ρs₁₀₀ at an applied voltage of 100 V and surface resistivity ρs₅₀₀ at an applied voltage of 500 V is 0.3 or less.

(((2)))

The recording medium transport and transfer belt according to (((1))),
wherein the surface resistivity ρs₅₀₀ at an applied voltage of 500 V is 9.5 log Ω/□ or more.

(((3)))

In the recording medium transport and transfer belt according to (((1))) or (((2))),
wherein volume resistivity ρv1₅₀₀ of the base material layer at an applied voltage of 500 V is smaller than volume resistivity ρv2₅₀₀ of the surface layer at an applied voltage of 500 V.

(((4)))

The recording medium transport and transfer belt according to any one of (((1)))) to (((3))),
wherein a difference (ρv1₁₀₀−ρv1₅₀₀) between volume resistivity ρv1₁₀₀ at an applied voltage of 100 V and volume resistivity ρv1₅₀₀ at an applied voltage of 500 V in the base material layer is 1.2 or less.

(((5)))

In the recording medium transport and transfer belt according to any one of (((1))) to (((4))),
wherein a thickness of the surface layer with respect to a total thickness of the recording medium transport and transfer belt is 0.6% or more and 3% or less.

(((6)))

In the recording medium transport and transfer belt according to any one of (((1))) to (((5))),
wherein volume resistivity ρv1₅₀₀ of the base material layer at an applied voltage of 500 V is smaller than volume resistivity ρv2₅₀₀ of the surface layer at an applied voltage of 500 V, and a thickness of the surface layer with respect to a total thickness of the recording medium transport and transfer belt is 0.6% or more and 3% or less.

(((7)))

The recording medium transport and transfer belt according to any one of (((1))) to (((6))),
wherein a difference (ρv1₁₀₀−ρv1₅₀₀) between volume resistivity ρv1₁₀₀ at an applied voltage of 100 V and volume resistivity ρv1₅₀₀ at an applied voltage of 500 Vin the base material layer is 1.2 or less, and a thickness of the surface layer with respect to a total thickness of the recording medium transport and transfer belt is 0.6% or more and 3% or less.

(((8)))

The recording medium transport and transfer belt according to any one of (((1))) to (((7))),
wherein volume resistivity ρv1₅₀₀ of the base material layer at an applied voltage of 500 V is smaller than volume resistivity ρv2₅₀₀ of the surface layer at an applied voltage of 500 V, and a difference (ρv1₁₀₀−ρv1₅₀₀) between volume resistivity ρv1₁₀₀ at an applied voltage of 100 V and volume resistivity ρv1₅₀₀ at an applied voltage of 500 V in the base material layer is 1.2 or less.

(((9)))

A belt unit comprising:
the recording medium transport and transfer belt according to any one of (((1))) to (((8))); and
a plurality of rolls around which the recording medium transport and transfer belt is wound in a tensioned state,
wherein at least one of the plurality of rolls is a drive roll that rotates the recording medium transport and transfer belt, and.
the belt unit is mounted to and demounted from an image forming apparatus.

(((10)))

An image forming apparatus comprising:
an image carrier;
a charging unit that charges a surface of the image carrier;
an electrostatic charge image forming unit that forms an electrostatic charge image on the charged surface of the image carrier;
a developing unit that accommodates a developing agent containing toner and develops the electrostatic charge image formed on the surface of the image carrier by using the developing agent to form a toner image; and
a transfer unit that includes the belt unit according to (((9))) and transfers the toner image to a recording medium.

(((11)))

The image forming apparatus according to (((10))), the transfer unit includes
an intermediate transfer body, a primary transfer unit that transfers the toner image to a surface of the intermediate transfer body, and a secondary transfer unit that transfers the toner image transferred to the surface of the intermediate transfer body to the recording medium, and
the secondary transfer unit includes the belt unit according to (((9))).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording medium transport and transfer belt comprising:
at least a base material layer and a surface layer,
wherein a ratio (ρs₅₀₀/ρv₅₀₀) between surface resistivity ρs₅₀₀ and volume resistivity ρv₅₀₀ at an applied voltage of 500 V is 1.0 or more, and
a difference (ρs₁₀₀−ρs₅₀₀) between surface resistivity ρs₁₀₀ at an applied voltage of 100 V and surface resistivity ρs₅₀₀ at an applied voltage of 500 V is 0.3 or less.

2. The recording medium transport and transfer belt according to claim 1,
wherein the surface resistivity ρs₅₀₀ at an applied voltage of 500 V is 9.5 log Ω/□ or more.

3. The recording medium transport and transfer belt according to claim 1,
wherein volume resistivity ρv1₅₀₀ of the base material layer at an applied voltage of 500 V is smaller than volume resistivity ρv2₅₀₀ of the surface layer at an applied voltage of 500 V.

4. The recording medium transport and transfer belt according to claim 1,
wherein a difference (ρv1₁₀₀−ρv1₅₀₀) between volume resistivity ρv1₁₀₀ at an applied voltage of 100 V and volume resistivity ρv1₅₀₀ at an applied voltage of 500 V in the base material layer is 1.2 or less.

5. The recording medium transport and transfer belt according to claim 1,
wherein a thickness of the surface layer with respect to a total thickness of the recording medium transport and transfer belt is 0.6% or more and 3% or less.

6. The recording medium transport and transfer belt according to claim 1,
wherein volume resistivity ρv1₅₀₀ of the base material layer at an applied voltage of 500 V is smaller than volume resistivity ρv2₅₀₀ of the surface layer at an applied voltage of 500 V, and a thickness of the surface layer with respect to a total thickness of the recording medium transport and transfer belt is 0.6% or more and 3% or less.

7. The recording medium transport and transfer belt according to claim 1,
wherein a difference (ρv1₁₀₀−ρv1₅₀₀) between volume resistivity ρv1₁₀₀ at an applied voltage of 100 V and volume resistivity ρv1₅₀₀ at an applied voltage of 500 V in the base material layer is 1.2 or less, and a thickness of the surface layer with respect to a total thickness of the recording medium transport and transfer belt is 0.6% or more and 3% or less.

8. The recording medium transport and transfer belt according to claim 1,
wherein volume resistivity ρv1₅₀₀ of the base material layer at an applied voltage of 500 V is smaller than volume resistivity ρv2₅₀₀ of the surface layer at an applied voltage of 500 V, and a difference (ρv1₁₀₀−ρv1₅₀₀) between volume resistivity ρv1₁₀₀ at an applied voltage of 100 V and volume resistivity ρv1₅₀₀ at an applied voltage of 500 V in the base material layer is 1.2 or less.

9. A belt unit comprising:
the recording medium transport and transfer belt according to claim 1; and
a plurality of rolls around which the recording medium transport and transfer belt is wound in a tensioned state,
wherein at least one of the plurality of rolls is a drive roll that rotates the recording medium transport and transfer belt, and
the belt unit is mounted to and demounted from an image forming apparatus.

10. A belt unit comprising:
the recording medium transport and transfer belt according to claim 2; and
a plurality of rolls around which the recording medium transport and transfer belt is wound in a tensioned state,
wherein at least one of the plurality of rolls is a drive roll that rotates the recording medium transport and transfer belt, and
the belt unit is mounted to and demounted from an image forming apparatus.

11. A belt unit comprising:
the recording medium transport and transfer belt according to claim 3; and
a plurality of rolls around which the recording medium transport and transfer belt is wound in a tensioned state,
wherein at least one of the plurality of rolls is a drive roll that rotates the recording medium transport and transfer belt, and
the belt unit is mounted to and demounted from an image forming apparatus.

12. A belt unit comprising:
the recording medium transport and transfer belt according to claim 4; and
a plurality of rolls around which the recording medium transport and transfer belt is wound in a tensioned state,
wherein at least one of the plurality of rolls is a drive roll that rotates the recording medium transport and transfer belt, and
the belt unit is mounted to and demounted from an image forming apparatus.

13. A belt unit comprising:
the recording medium transport and transfer belt according to claim 5; and
a plurality of rolls around which the recording medium transport and transfer belt is wound in a tensioned state,
wherein at least one of the plurality of rolls is a drive roll that rotates the recording medium transport and transfer belt, and
the belt unit is mounted to and demounted from an image forming apparatus.

14. A belt unit comprising:
the recording medium transport and transfer belt according to claim 6; and
a plurality of rolls around which the recording medium transport and transfer belt is wound in a tensioned state,
wherein at least one of the plurality of rolls is a drive roll that rotates the recording medium transport and transfer belt, and
the belt unit is mounted to and demounted from an image forming apparatus.

15. A belt unit comprising:
the recording medium transport and transfer belt according to claim 7; and
a plurality of rolls around which the recording medium transport and transfer belt is wound in a tensioned state,
wherein at least one of the plurality of rolls is a drive roll that rotates the recording medium transport and transfer belt, and
the belt unit is mounted to and demounted from an image forming apparatus.

16. A belt unit comprising:
the recording medium transport and transfer belt according to claim 8; and
a plurality of rolls around which the recording medium transport and transfer belt is wound in a tensioned state,
wherein at least one of the plurality of rolls is a drive roll that rotates the recording medium transport and transfer belt, and
the belt unit is mounted to and demounted from an image forming apparatus.

17. An image forming apparatus comprising:
an image carrier;
a charging unit that charges a surface of the image carrier;
an electrostatic charge image forming unit that forms an electrostatic charge image on the charged surface of the image carrier;
a developing unit that accommodates a developing agent containing toner and develops the electrostatic charge image formed on the surface of the image carrier by using the developing agent to form a toner image; and
a transfer unit that includes the belt unit according to claim 9 and transfers the toner image to a recording medium.

18. An image forming apparatus comprising:
an image carrier;
a charging unit that charges a surface of the image carrier;
an electrostatic charge image forming unit that forms an electrostatic charge image on the charged surface of the image carrier;
a developing unit that accommodates a developing agent containing toner and develops the electrostatic charge image formed on the surface of the image carrier by using the developing agent to form a toner image; and
a transfer unit that includes the belt unit according to claim 10 and transfers the toner image to a recording medium.

19. An image forming apparatus comprising:
an image carrier;
a charging unit that charges a surface of the image carrier;
an electrostatic charge image forming unit that forms an electrostatic charge image on the charged surface of the image carrier;
a developing unit that accommodates a developing agent containing toner and develops the electrostatic charge image formed on the surface of the image carrier by using the developing agent to form a toner image; and
a transfer unit that includes the belt unit according to claim 11 and transfers the toner image to a recording medium.

20. The image forming apparatus according to claim 17,
wherein the transfer unit includes
an intermediate transfer body, a primary transfer unit that transfers the toner image to a surface of the intermediate transfer body, and a secondary transfer unit that transfers the toner image transferred to the surface of the intermediate transfer body to the recording medium, and
the secondary transfer unit includes the belt unit.
